(19) United States
(12) Patent Application Publication
(10) Pub. No.: US 2025/0336661 A1
(43) Pub. Date: Oct. 30, 2025

(54) ELECTROSPRAY EMITTER WITH NON-UNIFORM RADIUS OF CURVATURE

(71) Applicant: Thermo Finnigan LLC, San Jose, CA (US)

(72) Inventors: Joshua Silveira, San Jose, CA (US); Eloy R. Wouters, San Jose, CA (US); Gary Schultz, San Jose, CA (US); Chandika Amarasinghe, San Jose, CA (US); Morgan Miller, San Jose, CA (US)

(73) Assignee: Thermo Finnigan LLC, San Jose, CA (US)

(21) Appl. No.: 18/645,244

(22) Filed: Apr. 24, 2024

(51) Int. Cl. H01J 49/16

(52) U.S. Cl. CPC H01J 49/167

(57) ABSTRACT

Multiple droplet streams are produced with shaped apertures that are situated at distal ends of flow members. The droplet streams interact with and are desolvated by a shear gas flow. A variable number of droplet streams at fixed locations can be produced by selection of a suitable extraction electric field.

### FIELD

The disclosure pertains to the production and desolvation of droplet streams for providing analytes to mass spectrometer systems.

### BACKGROUND

Analyte ionization efficiency of electrospray ionization (ESI) mass spectrometry (MS) depends principally on initial droplet sizes emanating from a Taylor cone. The total ion current should theoretically increase with the square-root of the number of electrospray plumes, but interactions between adjacent plumes reduce the theoretical ion current improvement, owing to space charge repulsion. The concept of using multiple nozzles has been used to improve the sensitivity of electrospray ionization (ESI). This approach has been implemented by branching a single flow channel into a series of parallel paths that each terminate into an independent ESI nozzle. Individual nozzles are commonly spaced by micron-scale dimensions. When coupled with liquid chromatography (LC), multi-nozzle emitters allow for the robustness of LC performed at higher flow rates with the sensitivity of ESI performed at lower flow rates. However, further increases in ionization efficiency are desirable, especially approaches that promote mixing between droplet streams and a surrounding nebulizing gas flow.

### SUMMARY

The disclosure pertains generally to methods, systems, and apparatus that use a single nozzle emitter geometry having a shaped aperture that is operable to produce a reproducible multi-droplet spray with defined nucleation points. Anchoring the base of the Taylor cones associated with each of the droplet streams to specific locations along the shaped emitter aperture can provide emission stability and reproducibility. Anchor points for the droplet streams can be created by shaping one or more apertures, typically by altering the cylindrical or other symmetry of a flow channel.

These and other features and advantages of the disclosed technology will become more apparent from the following detailed description, which proceeds with reference to the accompanying figures.

### BRIEF DESCRIPTION OF THE DRAWINGS

FIG. 1A-1B are sectional views illustrating production of multiple droplet jets from fixed locations defined by a shaped aperture.

FIGS. 1C-1D are respective end views of the shaped aperture of FIGS. 1A-1B.

FIG. 2A illustrates a representative shaped aperture defined at a distal end of a capillary, wherein the capillary is situated within a tube that can provide a sheath flow for desolvation of the droplets.

FIG. 2B illustrates a shaped aperture such as illustrated in FIGS. 2A-2B situated at least partially withing a tube operable to provide a sheath gas flow for desolvation of droplet streams.

FIG. 2C illustrates the production of increasing numbers of droplet jets with a shaped aperture such as shown in FIG. 2A in response to an increasing voltage that is applied to produce an extraction electric field.

FIGS. 3A-3E illustrate additional representative shaped apertures defined at distal ends of capillaries.

FIG. 4A illustrates a shaped aperture defined by combining two curved sections.

FIG. 4B illustrates a shaped aperture such as shown in FIG. 4A situated within a tube operable to provide a sheath gas flow.

FIGS. 5A-5B illustrate additional examples of shaped apertures operable to produce multiple droplet streams at fixed locations.

FIGS. 5C-5D illustrate shaped apertures situated within a tube operable to provide a sheath gas flow.

FIGS. 6A-6B illustrate a capillary having a shaped aperture defined by forming notches or slots in a distal end. FIG. 6A includes perspective view of a capillary before and after forming the shaped aperture and FIG. 6B is an end view.

FIG. 6C illustrates a shaped aperture such as shown in FIG. 6B having a central obstruction and situated within a tube that can provide a coaxial sheath gas flow.

FIGS. 7A-7B illustrate a pressed capillary having a shaped aperture defined by forming notches or slots in a distal end. FIG. 7A includes perspective view of the pressed capillary before and after forming the shaped aperture and FIG. 7B is an end view.

FIG. 8 illustrates a shaped aperture defining by a plurality of slots and a central flow obstruction.

FIG. 9 illustrates a system operable to produce multiple droplet jets using a shaped aperture.

FIG. 10 illustrates a representative method of producing multiple droplet jets using a shaped aperture.

FIG. 11A illustrates a shaped aperture defined by providing a plurality of obstructions within a capillary.

FIG. 11B illustrates a shaped aperture defined in a plate situated at a distal end of a flow member.

FIG. 12 illustrates a representative method of providing capillaries or other flow members with shaped apertures.

FIG. 13 illustrates production of droplet streams from a capillary having a shaped aperture that is not orthogonal to a flow direction.

### DETAILED DESCRIPTION

The disclosure pertains to approaches that use a single nozzle emitter geometry that is capable of producing multiple droplet streams with defined nucleation points. These approaches can be used in combination with slotted mass spectrometer inlets as described in Wouters et al., U.S. Pat. No. 9,761,427, which is incorporated herein by reference. The multiple droplet streams tend to have velocity components both along an axis of an analyte flow at an emitting aperture and orthogonal to the axis. The orthogonal components are referred to herein as radial components. Typically, these radial components are produced or enhanced based on electrostatic repulsion of the multiple droplet streams from each other. For convenience, in some cases, droplet streams having non-zero radial velocity components are referred to as non-axial.

In the disclosure, droplet emitting aperture shapes are described based on shapes that are defined by straight line segments or curved segments, or both. In some examples, shapes are referred as oval, elliptical, polygonal (such a rectangular or hexagonal), but it will be appreciated that such terms are used for convenient description and as applied to define flow channels, deviations from such exact geometric shapes are common. Accordingly, as used herein, such shape terms are to be understood as including deviations from exact geometric shapes. As used herein, a “stadium” shape is formed by first and second curved sections such as circular, elliptical, or oval sections that are joined by a rectangular section. Typically, the first and section curved sections have the same shape. In one example, a stadium shape is an obround shape in which the first and second curved sections are semicircular sections of radius r and are joined by a rectangular section of height 2r between the semicircular sections. In the examples, droplet streams are formed at distal ends of flow channels that are generally defined in flow members having distal surfaces that are orthogonal to a flow axis, flow channel distal surfaces can be otherwise arranged.

In the examples, droplet streams are directed to mix with a surrounding or partially surrounding gas flow to remove solvent from the droplet streams. This surrounding or partially surrounding gas and the associated gas flow are referred to herein as a sheath gas and a sheath gas flow. Typically, sheath gas flow is coaxial with an axis of a flow of an analyte/solvent mixture from which droplet streams are produced. However, a sheath gas flow about a flow channel can be directed toward a flow axis to aid in directing droplet streams to an axis in order to, for example, be transmitted to a mass spectrometer input aperture.

As used herein, a flow channel is a volume that permits a fluid flow from a proximal end to a distal end, wherein droplet streams are emitted from or at the distal end. Flow channels can be defined in tubes of arbitrary cross section or by forming channels in a solid member by, for example, boring, milling, etching, or other process. In many practical examples, a flow channel is defined by internal surfaces of a capillary tube having a circular cross-section. In typical examples, a capillary tube having a circular or other cross section (oval or polygonal, for example) directs a fluid flow to a shaped aperture at a distal end. Cross-sectional dimensions of such capillary tubes are typically less than 1 mm, 0.5 mm, 0.25 mm, 0.10 mm, or 0.05 mm. Capillary flow channels can be defined in other solid members, but glass or metal or other tubes are convenient. It is convenient to provide a suitable emitting aperture by shaping a distal end of a flow member.

In the examples, fluid flows are generally described based on a flow of a solvent that contains an analyte. However, in general, flows of any carrier fluid that contains an analyte of interest can be used. For convenient description, removal of some or all of a carrier fluid (or a solvent) from a droplet stream is referred to herein as desolvation.

### General Terminology

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatuses are referred to as “lowest”, “best”, “minimum,” or the like. It will be appreciated that such descriptions are intended to indicate that a selection among many used functional alternatives can be made, and such selections need not be better, smaller, or otherwise preferable to other selections.

Examples are described with reference to directions indicated as “above,” “below,” “upper,” “lower,” and the like. These terms are used for convenient description, but do not imply any particular spatial orientation.

### Example 1

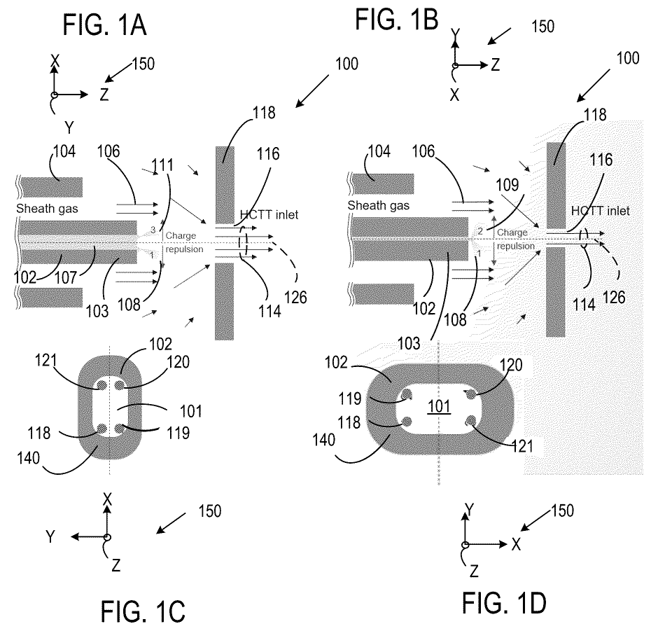

FIGS. 1A-1D illustrate certain aspects of multi-droplet-stream emission using an XYZ-coordinate system 150 in which a circle represents a coordinate axis extending out of the plane of the drawing. This coordinate system is provided for ease of illustration only. Referring to FIGS. 1A-1B, a portion 100 of a representative mass spectrometry system includes a capillary 102 or other flow member having a distal end 103 defining an emitting aperture 101 shaped as illustrated in FIGS. 1C-1D. The capillary 102 defines a flow channel 107 that delivers a flow 114 of an analyte-containing fluid to an inlet aperture 116 defined in an inlet plate 118. The capillary 102 is situated at least partially within a sheath tube 104 that provides a coaxial flow of a sheath gas 106 at an exterior of the capillary. In FIGS. 1C-1D, a distal end 103 of the capillary 102 is illustrated and has a shaped (in this case, non-circular) cross section that defines the emitting aperture 101. Other portions of the capillary 102 can have a circular cross-section or the entire length of the capillary 102 can have a common, shaped cross-section.

As subjected to a sufficient electric field, droplet streams 108, 109, 111 are produced at respective locations 118, 119, 121 in the emitting aperture 101; an additional droplet stream is produced at location 120 but this droplet stream is not illustrated in FIGS. 1A-1B. The droplet streams propagate away from an axis 126 of the flow channel due at least in part to charge repulsion to mix with the shield gas flow 106 to desolvate the droplet streams. Each of the droplet streams can propagate with the same or different radial and axial components of velocity but with different azimuthal angles measured in an XY plane about a Z-axis of the coordinate system 150. The sheath gas flow 106 also tends to interact with the droplet streams to aid in directing the droplet streams to the inlet aperture 116, typically by one or more of increasing an axial component of velocity so the radial displacements of the droplet streams at the inlet aperture are limited, or by decreasing the radial components of the droplet velocities. In the example of FIGS. 1A-1D, an end surface 140 of the capillary 102 associated with the emitting aperture is substantially orthogonal to the flow axis 126.

### Example 2

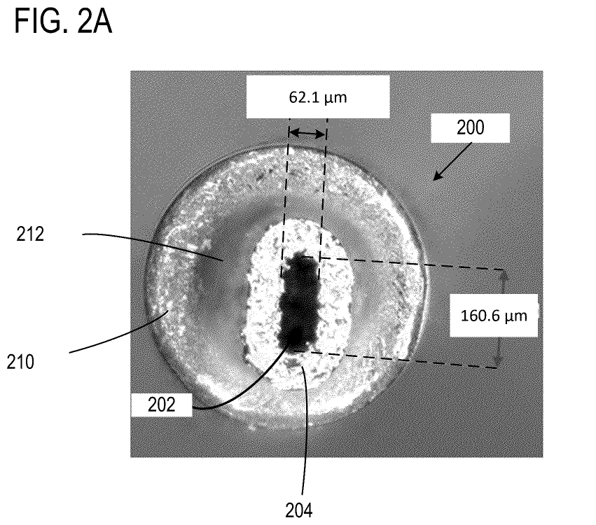

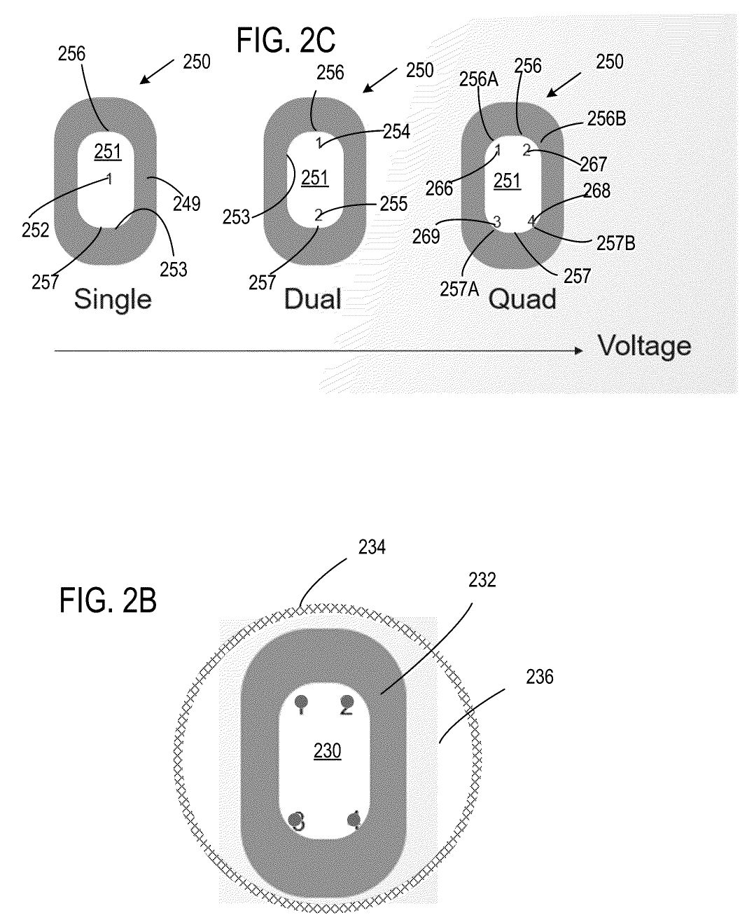

FIG. 2A is a photograph of a distal end 200 of a representative capillary that defines a shaped aperture 202 that provides a flow channel in a capillary wall 204. A sheath 210 is situated about the capillary and defines a volume 212 suitable for flow of a sheath gas. Representative dimensions are shown in FIG. 2A. FIG. 2B is a schematic representation of an arrangement such as shown in FIG. 2A. An aperture 230 is defined by a capillary tube wall 232 that is surrounded by a sheath tube 234 to provide a sheath gas flow in a volume 236 between the capillary wall 232 and the sheath tube 234. Potential emission locations are indicated with heavy dots.

FIG. 2C shows a capillary end 250 such as shown in FIG. 2A illustrating locations at which droplet streams in an aperture 251 defined by a capillary wall 249 are produced as a function of applied voltage, i.e., applied electric field. At a first, lower voltage, a central location 252 provides a single droplet stream. At a higher voltage, droplet streams are produced at locations 254, 255 that are associated with opposing curved portions 256, 257 of an interior surface 253 of the aperture 251. At still higher voltages, droplet streams are produced at locations 266-269 that are associated with corners of the opposed curved portions 256, 257 of an interior surface 253 of the aperture 251. By adjusting the applied voltage, one, two, or four droplet streams can be produced from fixed locations.

### Example 3

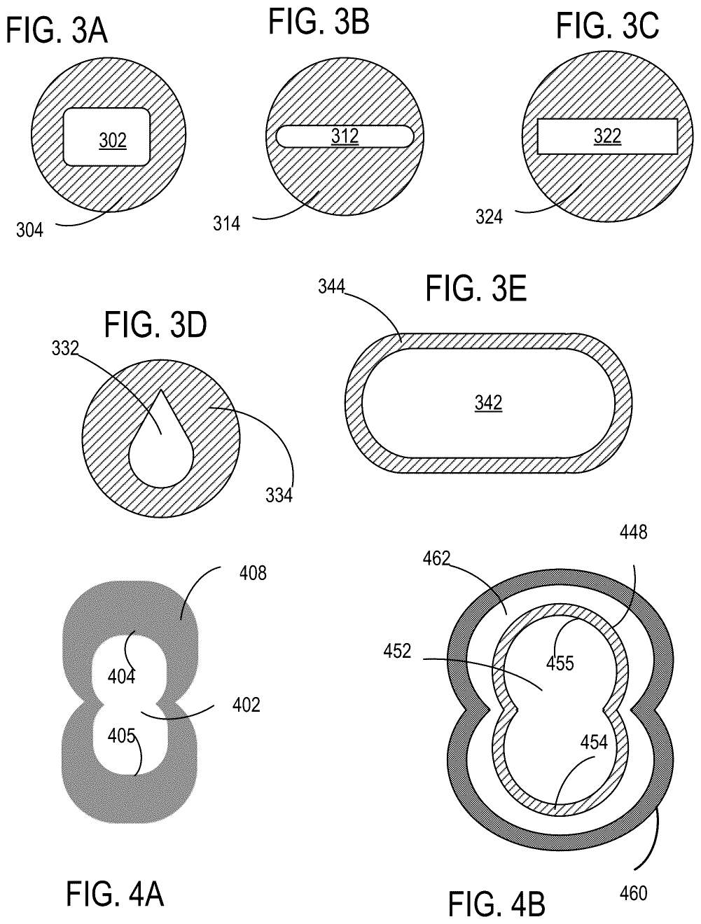

FIGS. 3A-3E are scaled distal end views of representative apertures 302, 312, 322, 332, 342 that terminate flow channels defined by channel walls 304, 314, 324, 334. In some examples, these apertures are defined in suitably shaped tubing walls, but can be defined in other ways as well. In addition, the apertures 302, 312, 322, 332, 342 are situated at distal ends of the respective channel walls 304, 314, 324, 334, 344. The aperture 302 of FIG. 3A is approximately rectangular with curved corners while the aperture 312 of FIG. 3B is approximately racetrack shaped. The aperture 332 of FIG. 3D is teardrop shaped and the aperture 342 of FIG. 3E is approximately racetrack shaped and the corresponding channel wall 344 is similarly shaped, although it need not be. The apertures 312, 322 can also be referred to as “slot-shaped” and such apertures can have linear or curved surfaces that terminate the slot. The apertures of FIGS. 3A-3E permit producing of one, two, or more droplet streams at fixed locations depending on the magnitude of an extraction electric field. Droplet streams tend to be produced at or near edges and locations associated with aperture curvature or changes in aperture curvature.

### Example 4

FIGS. 4A-4B are end views of additional example shaped apertures situated at distal ends of flow channels. In FIG. 4A, an aperture 402 is defined by first and second curved portions 404, 405 of an interior wall of a flow tube 408. The first and second curved portions 404, 405 are approximately circular but can be elliptical, oblong, or other shapes. As shown, the first and second curved portions 404, 405 have substantially the same shape, but can have different shapes. FIG. 4B illustrates a similar aperture 452 that is defined by first and second curved portions 454, 455 of an interior wall of a flow tube 448. A similarly shaped sheath tube 460 is situated to define a volume 462 for flow of a sheath gas. The sheath tube 460 need not have a shaped cross-section as shown and can be, for example, a cylindrical tube that is situated at least about a portion of the flow tube 448. Typically, a sheath gas flow is to be provided proximate locations at which droplet streams are produced to enhance desolvation.

### Example 5

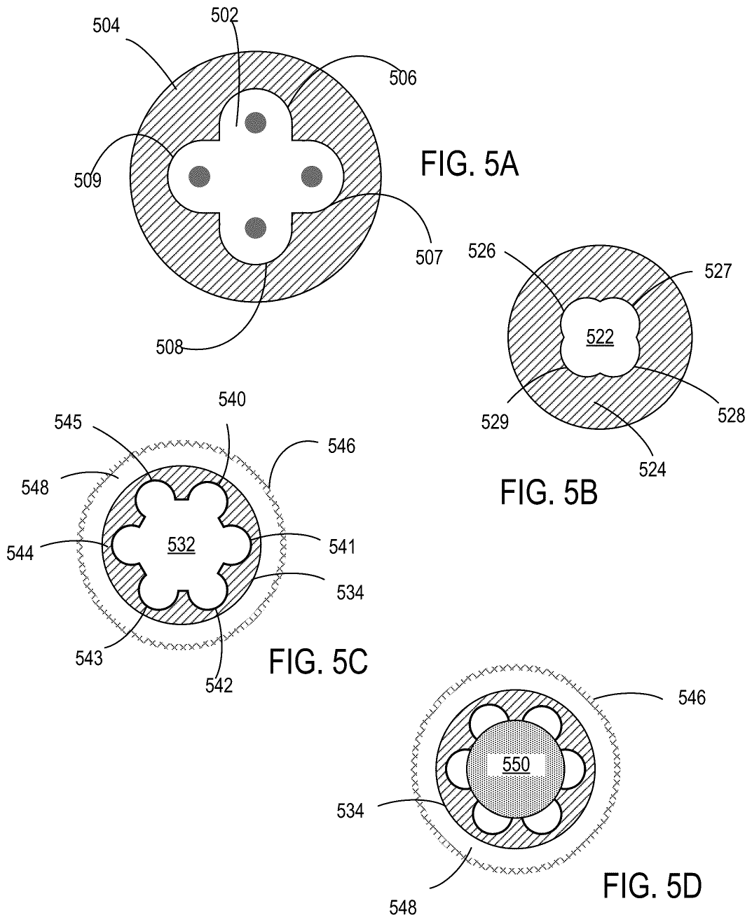

FIGS. 5A-5D illustrate additional apertures defined in tubes having circular cross-sections that can be used to produce multiple droplet streams. In FIG. 5A, an aperture 502 is defined in a tube wall 504 by opposing curved sections 506-509 having a common curvature and facing a central axis of the aperture 502. Locations that can be associated with droplet streams at various extraction fields are indicated with heavy dots, and with a suitable applied voltage, four off-axis droplet streams can be produced. FIG. 5B illustrates an aperture 522 defined in a tube wall 524 by opposing plurality of curved sections 526-529 having a common curvature and facing a central axis of the aperture 522. More or fewer curved sections can be used and some or all of the curved sections 526-529 can have different radii, have different shapes, or otherwise differ. With application of a suitable voltage, droplet streams from fixed locations with respect to each of the curved sections can be produced and an additional droplet stream can be produced at a center of the aperture 522.

FIG. 5C illustrates an aperture 532 defined in a tube wall 534 by a plurality of curved sections 540-545 having a common curvature and facing a central axis of the aperture 532. More or fewer curved sections can be used and some or all of the curved sections 540-545 can have different radii, have different shapes, or otherwise differ. With application of a suitable voltage, droplet streams from fixed locations with respect to each of the curved sections can be produced. The tube wall 534 is situated at least partially withing a sheath gas tube 546 that defines a volume 548 for a sheath gas flow. FIG. 5D illustrates the arrangement of FIG. 5C with a bead 550 situated to block a central portion of the aperture 532, thereby better defining droplet emitting regions and blocking or inhibiting production of a droplet stream at a center of the aperture 532. An axial droplet stream tends not to mix with shear gas flow for desolvation and is generally undesirable.

### Example 6

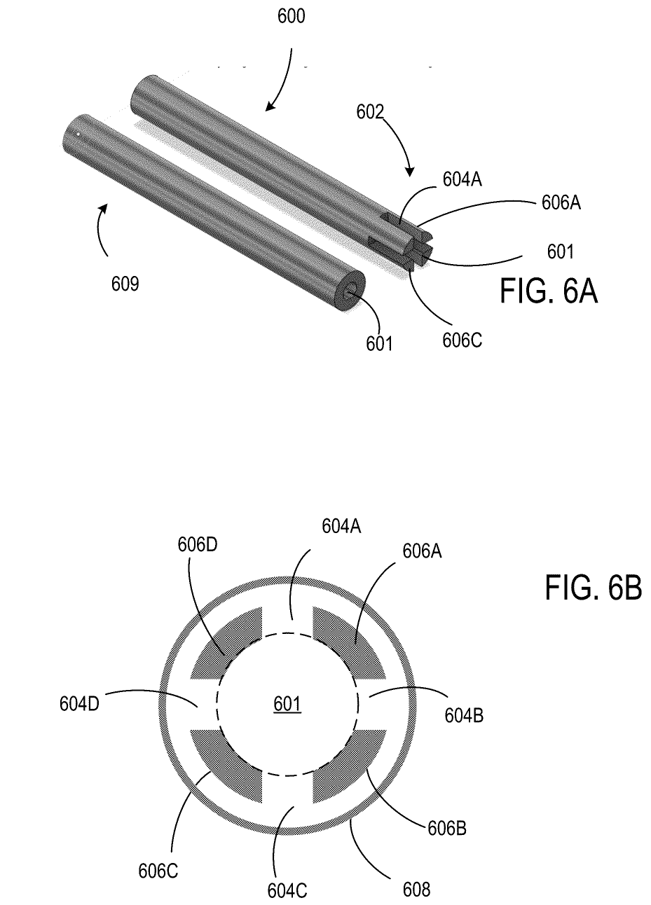

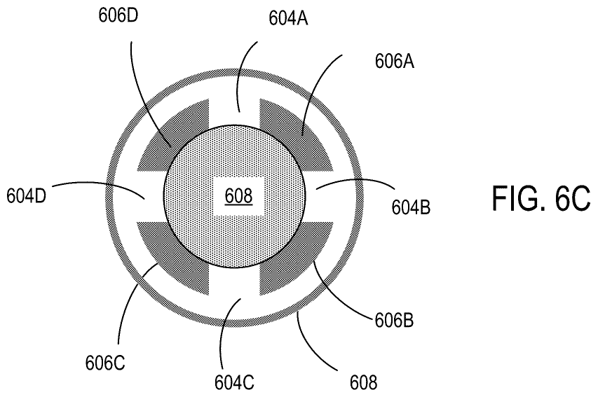

Referring to FIGS. 6A-6B, a representative flow channel for producing multiple droplet streams is defined in a capillary 600 (show as 609 prior to processing) having a circular aperture 601 which is processed at a distal end 602 to define slots 604A-604D by milling (such as EDM) or other process so that tines 606A-606D remain. In FIG. 6B, a sheath gas flow tube 608 is situated coaxially with the capillary 600 for provision of a sheath gas.

FIG. 6C is view of a distal end of another example flow tube similar to that of FIGS. 6A-6B with a bead 608 (or other obstruction) situated to block the central aperture 601 and contacting the tines 606A-606D and thereby inhibit production of an axial droplet stream while allowing droplet streams that have propagate radially away from a center of the circular aperture to be produce at locations defined by the slots 604A-604D.

### Example 7

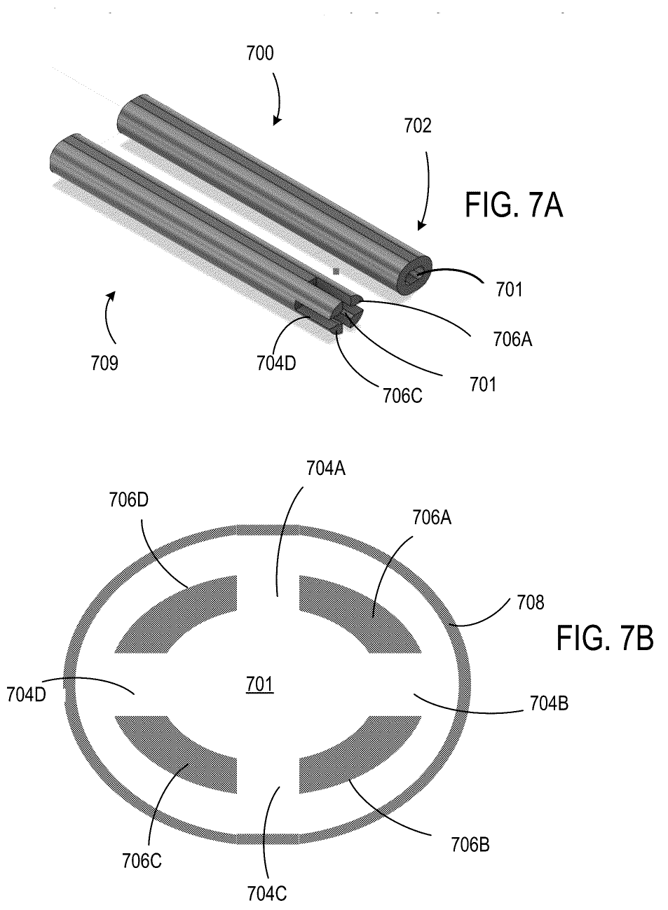

Referring to FIGS. 7A-7B, a representative flow channel for producing multiple droplet streams is defined in a capillary 700 having an elliptical, oblong, or other non-circular aperture 701 which is processed at a distal end 702 to define slots 704A-704D by milling (such as EDM) or other process so that tines 706A-706D remain. In FIG. 7B, a sheath gas flow tube 708 is situated coaxially with the capillary 700 for provision of a sheath gas and a bead can be provided as shown in FIG. 6C and discussed above so that droplet streams that have propagate radially away from a center of the circular aperture can be produced at locations defined by the slots 704A-704D and production of an axial droplet stream inhibited.

### Example 8

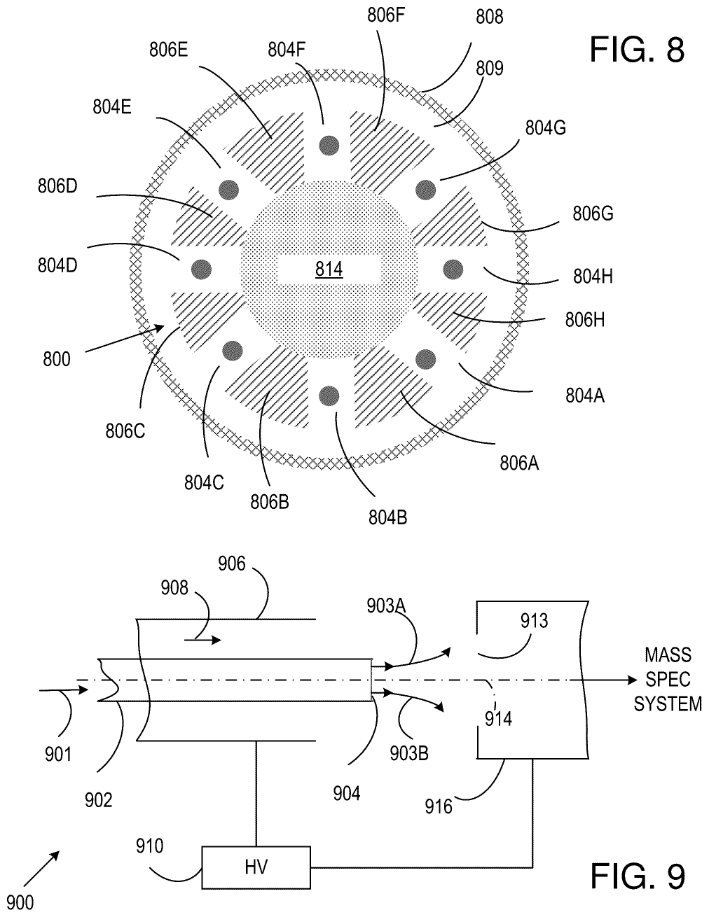

In the examples of FIGS. 6A-7B, four slots are formed in a capillary wall but fewer or more slots can be provided to produce fewer or more radially directed droplet streams. Referring to FIGS. 8, a representative flow channel for producing multiple droplet streams is defined in a capillary distal end of a capillary 800 that is processed to define slots 804A-804H by milling (such as EDM) or other process so that tines 806A-806BH remain. A sheath gas flow tube 808 is situated coaxially with the capillary 800 for provision of a sheath gas in a volume 809 and a bead 814 can be provided so that droplet streams propagate radially away from a center of the circular aperture can be produced at locations defined by the slots 804A-804H and production of an axial droplet stream inhibited. For convenience, locations associated with droplet stream production are indicated with heavy dots.

In the above examples, slots are evenly spaced and sized about a capillary but in other examples, slots can be arbitrarily spaced or sized. With even spacing and sizes, droplet streams tend to be produced in each slot at the same applied electric field while with non-uniform spacings, the required electric field can be different for each slot. By providing slots or other droplet-producing apertures of different shapes, sizes, or positions, different numbers of droplet streams can be produced at different electric field strengths, with droplet streams that continue to be emitted for fixed locations as electric field strength increases. In some other cases, such as illustrated in FIG. 2C, droplet stream emission locations vary as electric field strength is increased, although at each electric field strength, emission locations are fixed.

### Example 9

Referring to FIG. 9, a representative system 900 for producing multiple radially-propagating droplet streams such as representative droplet streams 903A, 903B includes a capillary 902 that is situated to receive an analyte/carrier liquid 901 and has a droplet emitting aperture 904 such as discussed above. A sheath tube 906 is situated about at least a portion of the capillary 902 to produce as sheath gas flow 908 that is directed parallel to an axis 914 of the capillary 902. A power supply 910 is coupled to the sheath tube 906 and an ion inlet tube 916 (or other electrodes or components) to establish an electric field for the production of one or more droplet streams. The ion inlet tube 916 defines an inlet aperture 913 that receives the droplet streams 903A, 903B. The droplet streams 903A, 903B are illustrated as diverging from the axis 914 due to electrostatic repulsion that urges them toward the shear gas flow 908 which tends both to desolvate and direct the droplet streams 903A, 903B into the inlet aperture 913.

### Example 10

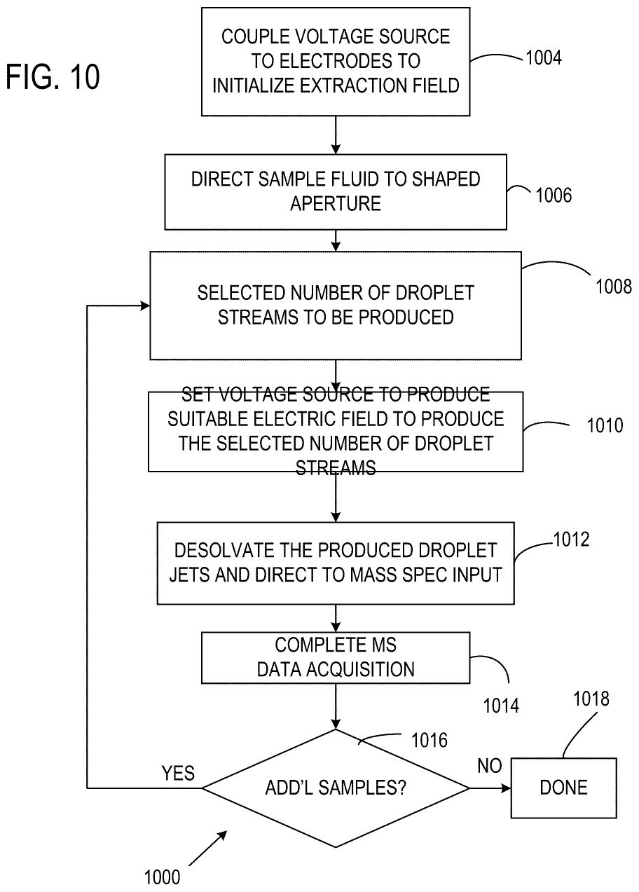

Referring to FIG. 10, a representative method 1000 includes coupling a voltage source to at least first and second electrodes to initialize an electric field suitable for extracting droplet streams at 1004. At 1004, a sample fluid (typically a solvent/analyte combination) is directed to a shaped emitting aperture. At 1008, a number of droplet streams to be produced is selected and at 1010, the voltage source is adjusted to produce the number streams by, for example, varying an applied voltage or using a stored value of voltage provided by a processor of a control system. At 1012, the droplet streams are formed, desolvated with a sheath gas and directed to an input of a suitable apparatus, such as a mass spectrometer. Upon completion of mass spectrum acquisition at 1014, it is determined at 1016 if additional samples are to be evaluated. If so, processing can return to 1008 to select a number of droplet streams, and a current number of droplet streams can continue to be used so that voltage settings are available and need not be re-determined. If no additional samples are to be evaluated, processing terminates at 1018. The acquired MS data can be communicated for evaluation during acquisition or upon completion of acquisition for some or all samples of interest.

### Example 11

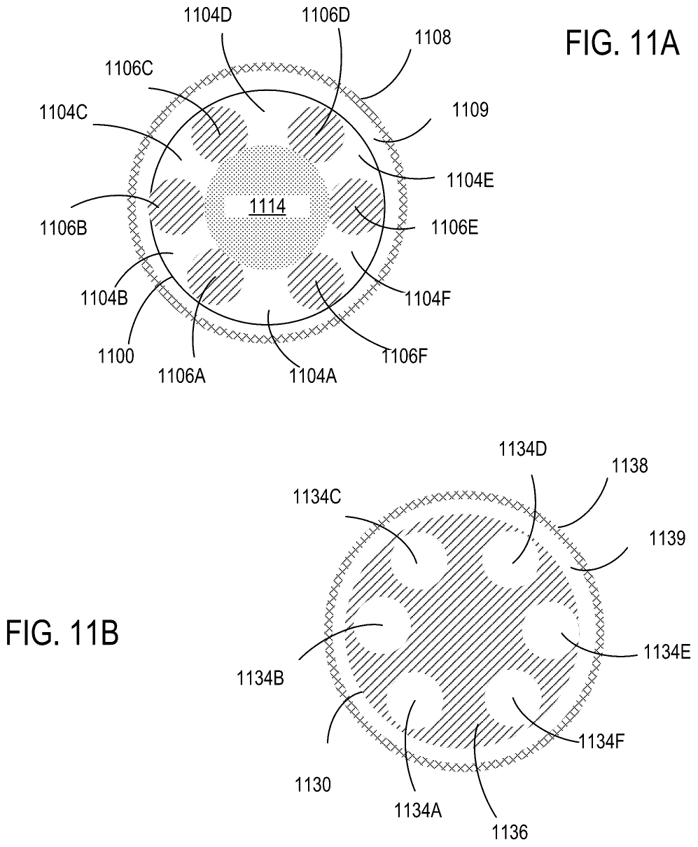

FIGS. 11A-11B illustrate additional flow channel distal end surfaces that can be used to produce multiple droplet streams. Referring to FIG. 11A, a representative flow channel for producing multiple droplet streams is defined in a distal end of a capillary 1100 that includes multiple apertures 1104A-1104F defined by obstructions 1106A-1106F. A sheath gas flow tube 1108 is situated coaxially with the capillary 1100 for provision of a sheath gas in a volume 1109 and a central obstruction 1114 can be provided so that droplet streams propagate radially away from a central axis at locations defined by the apertures 1104A-1104F and production of an axial droplet stream inhibited.

The apertures 1104A-1104F can be formed by etching, milling, boring or otherwise processing a plate situated and fixed to a distal end of the capillary 1100 or by situating a plurality of corresponding wires, fibers, or other elongated members within a flow channel. The central obstruction 1114 can be similarly formed by processing such a plate or providing a fiber, wire, or other obstruction within and along an axis of the flow channel.

Referring to FIG. 11B, a representative flow channel for producing multiple droplet streams is defined in a distal end of a capillary 1130 that includes multiple apertures 1134A-1134F defined in a plate 1136. A sheath gas flow tube 1138 is situated coaxially with the capillary 1130 for provision of a sheath gas in a volume 1139 and droplet streams can be produced at the apertures 1134A-1134F to propagate radially away from a central axis of the capillary.

### Example 12

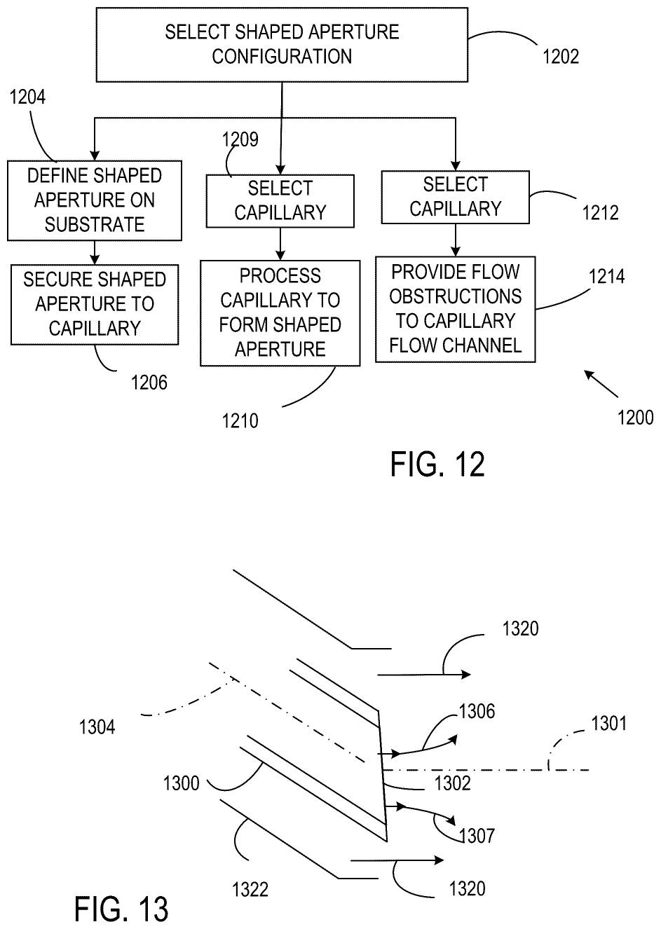

With reference to FIG. 12, a representative method 1200 of making a multi-droplet-stream emitter 1200 includes selecting a shaped aperture configuration at 1202 based on numbers and positions of droplet streams to be formed. In some examples, a suitable shaped aperture or apertures are formed on a substrate at 1204 and secured to distal end of a capillary at 1206. In another example, a suitable capillary is selected at 1209 and processed to form a shaped aperture at 1210, by, for example, compressing the distal end of the capillary in a vise or otherwise. In yet another example, a capillary is selected at 1212 and a plurality of flow obstructions are provided at 1214 at a distal end or along or within the flow channel provided by the capillary.

### Example 13

In the examples above, a flow channel axis and a direction of sheath gas flow are substantially the same and the sheath gas flow is referred to as coaxial. Other configurations are possible, though typically less convenient. For example, as shown in FIG. 13, a capillary 1300 having a shaped aperture 1302 at a distal end defines a flow axis 1304. Representative droplet streams 1306, 1307 are produced that need not be along the flow axis 1304. A sheath gas flow 1320 can be provided with suitable sheath tube 1322. The droplet streams 1306, 1307 are shown as diverging from an axis of emission 1301 due to electrostatic repulsion due to charging of the droplet streams associated with an applied electrostatic field by electrodes and voltage sources that are not shown in FIG. 13. In this way, the droplet streams mix with and are desolvated by the sheath gas.

### Disclosure Clauses

Clause 1 is a method, including: delivering a fluid through a flow channel to a shaped aperture at a distal end of the flow channel; establishing an electric field at the distal end of the flow channel to produce a plurality of droplet streams from the shaped aperture based on the fluid delivered to the distal end; at least partially desolvating each of the plurality of non-axial droplet streams in a sheath gas flow; and directing the desolvated non-axial droplet streams toward an inlet of a mass spectrometer.

Clause 2 includes the subject matter of Clause 1, and further specifies that the electric field is established to produce a selected number of droplet streams that propagate radially with respect to a flow channel axis and have associated emission locations.

Clause 3 includes the subject matter of any of Clauses 1-2, and further specifies that the electric field is variable to establish associated numbers of droplet streams.

Clause 4 includes the subject matter of any of Clauses 1-3, and further specifies that the shaped aperture includes a central obstruction.

Clause 5 includes the subject matter of any of Clauses 1-4, and further specifies that the flow channel is a capillary tube, and the shaped aperture is defined by the flow channel in the capillary tube and slots in a capillary tube wall.

Clause 6 includes the subject matter of any of Clauses 1-5, and further specifies that the flow channel is a capillary tube defining a flow channel having a circular cross-section and the shaped aperture is defined by a flattened portion of the capillary tube at the distal end.

Clause 7 includes the subject matter of any of Clauses 1-6, and further specifies that the capillary tube defines a flow channel having a circular cross-section and the shaped aperture is defined by a flattened portion of the capillary tube at the distal end.

Clause 8 includes the subject matter of any of Clauses 1-7, and further specifies that the shaped aperture is defined a plurality of slots in the flattened portion of a capillary tube.

Clause 9 includes the subject matter of any of Clauses 1-8, and further specifies that the flow channel is a capillary tube defining a flow channel having a circular cross-section and the shaped aperture is defined by an interior or exterior surface of the capillary tube at the distal end having a substantially stadium shape.

Clause 10 includes the subject matter of any of Clauses 1-9, and further specifies that the flow channel is a capillary tube having a segmented interior surface at a distal end, the segmented interior surface defining the shaped aperture.

Clause 11 includes the subject matter of any of Clauses 1-10, and further specifies that the segmented interior surface defining the shaped aperture includes a plurality of curved segments.

Clause 12 is an apparatus, including: a flow channel having a shaped aperture at a distal end; a first electrode and a second electrode situated to establish an electric field at the shaped aperture and operable to produce a plurality of droplet streams from a fluid in the flow channel; and a sheath situated about the flow channel and operable to provide a coaxial sheath gas flow proximate the distal end of the distal end of the flow channel, the coaxial sheath gas flow situated to receive and at least partially desolvate the plurality of droplet streams.

Clause 13 includes the subject matter of Clause 12, and further specifies that the flow channel is defined by a capillary.

Clause 14 includes the subject matter of any of Clauses 12-13, and further specifies that the shaped aperture is defined by a distal end of the capillary.

Clause 15 includes the subject matter of any of Clauses 12-14, and further specifies that the shaped aperture has a first length along a first axis and a second length along a second axis that is orthogonal to the first axis, wherein a ratio of the first length to the second length is at least 1.5.

Clause 16 includes the subject matter of any of Clauses 12-15, and further specifies that the shaped aperture is defined by a plurality of segments that define the flow channel at the distal end.

Clause 17 includes the subject matter of any of Clauses 12-16, and further specifies that the shaped aperture is defined by a plurality of curved segments that define the flow channel at the distal end.

Clause 18 includes the subject matter of any of Clauses 12-17, and further specifies that the shaped aperture is defined by a plurality of linear segments that define the flow channel at the distal end.

Clause 19 includes the subject matter of any of Clauses 12-18, and further includes a bead situated at the shaped aperture along an axis of the flow channel.

Clause 20 includes the subject matter of any of Clauses 12-19, and further specifies that the shaped aperture is defined by a plurality of slots in a capillary tube extending axially along the capillary at a distal end of the capillary, wherein the slots are azimuthally separated by respective capillary tube strips.

Clause 21 includes the subject matter of any of Clauses 12-20, and further includes a bead situated along an axis of the capillary, the bead having an outer surface contacting the capillary tube strips.

Clause 22 includes the subject matter of any of Clauses 12-21, and further specifies that the shaped aperture is defined by a plurality of curved sections, each of the curved sections operable to establish at least one corresponding droplet stream in response to the established electric field.

Clause 23 includes the subject matter of any of Clauses 12-22, and further includes a voltage source coupled to the first electrode and the second electrode and operable to select a number of droplet seams at associated fixed locations at the shaped aperture.

Clause 24 includes the subject matter of any of Clauses 12-23, and further includes a voltage source coupled to the first electrode and the second electrode and operable to select a number of droplet seams at associated fixed locations at the shaped aperture and to urge each of the droplet steams to propagate radially away from the flow channel axis toward the coaxial sheath gas flow.

In view of the many possible embodiments to which the principles of the disclosed technology may be applied, it should be recognized that the illustrated embodiments are only preferred examples and should not be taken as limiting the scope of the disclosure.

We claim:

1. A method, comprising:
delivering a fluid through a flow channel to a shaped aperture at a distal end of the flow channel;
establishing an electric field at the distal end of the flow channel to produce a plurality of droplet streams from the shaped aperture based on the fluid delivered to the distal end, the droplet streams propagating non-axially in response to charge repulsion among the plurality of droplet streams;
at least partially desolvating each of the plurality of non-axially propagating droplet streams in a sheath gas flow; and
directing the desolvated plurality of non-axially propagating droplet streams toward an inlet of a mass spectrometer.

2. The method of claim 1, wherein the electric field is established to produce a selected number of droplet streams that propagate radially with respect to a flow channel axis and have associated emission locations.

3. The method of claim 1, wherein the electric field is variable to establish associated numbers of droplet streams.

4. The method of claim 1, wherein the shaped aperture includes a central obstruction.

5. The method of claim 1, wherein the flow channel is a capillary tube, and the shaped aperture is defined by the flow channel in the capillary tube and slots in a capillary tube wall.

6. The method of claim 1, wherein the flow channel is a capillary tube defining a flow channel having a circular cross-section and the shaped aperture is defined by a flattened portion of the capillary tube at the distal end.

7. The method of claim 6, wherein the shaped aperture is defined by a plurality of slots in the flattened portion of a capillary tube.

8. The method of claim 1, wherein the flow channel is a capillary tube defining a flow channel having a circular cross-section and the shaped aperture is defined by a surface of the capillary tube at the distal end having a substantially stadium shape.

9. The method of claim 1, wherein the flow channel is a capillary tube defining a flow channel having a circular cross-section and the shaped aperture is defined by an interior surface of the capillary tube at the distal end having a substantially stadium shape.

10. The method of claim 1, wherein the flow channel is a capillary tube having a segmented interior surface at a distal end, the segmented interior surface defining the shaped aperture.

11. The method of claim 10, wherein the segmented interior surface defining the shaped aperture includes a plurality of curved segments.

12. An apparatus, comprising:
a flow channel having a shaped aperture at a distal end;
a first electrode and a second electrode situated to establish an electric field at the shaped aperture and operable to produce a plurality of droplet streams from a fluid in the flow channel; and
a sheath situated about the flow channel and operable to provide a coaxial sheath gas flow proximate the distal end of the distal end of the flow channel, the coaxial sheath gas flow situated to receive and at least partially desolvate the plurality of droplet streams.

13. The apparatus of claim 12, wherein the flow channel is defined by a capillary.

14. The apparatus of claim 13, wherein the shaped aperture is defined by a distal end of the capillary.

15. The apparatus of claim 13, wherein the shaped aperture has a first length along a first axis and a second length along a second axis that is orthogonal to the first axis, wherein a ratio of the first length to the second length is at least 1.5, 2.0, or 2.5.

16. The apparatus of claim 12, wherein the shaped aperture is defined by a plurality of segments that define the flow channel at the distal end.

17. The apparatus of claim 15, wherein the shaped aperture is defined by a plurality of curved segments that define the flow channel at the distal end.

18. The apparatus of claim 15, wherein the shaped aperture is defined by a plurality of linear segments that define the flow channel at the distal end.

19. The apparatus of claim 15, further comprising a bead situated at the shaped aperture along an axis of the flow channel.

20. The apparatus of claim 12, wherein the shaped aperture is defined by a plurality of slots in a capillary extending axially along the capillary at a distal end of the capillary, wherein the slots are azimuthally separated by respective capillary tube strips.

21. The apparatus of claim 20, further comprising a bead situated along an axis of the capillary, the bead having an outer surface contacting the capillary tube strips.

22. The apparatus of claim 12, wherein the shaped aperture is defined by a plurality of curved sections, each of the curved sections operable to establish at least one corresponding droplet stream in response to the established electric field.

23. The apparatus of claim 12, further comprising a voltage source coupled to the first electrode and the second electrode and operable to select a number of droplet streams at associated fixed locations at the shaped aperture.

24. The apparatus of claim 12, further comprising a voltage source coupled to the first electrode and the second electrode and operable to select a number of droplet streams at associated fixed locations at the shaped aperture and to urge each of the droplet streams to propagate radially away from a flow channel axis toward the coaxial sheath gas flow.
